(19) United States
(12) Patent Application Publication
(10) Pub. No.: US 2025/0377951 A1
(43) Pub. Date: Dec. 11, 2025

(54) ARTIFICIAL INTELLIGENCE WORKLOAD SCHEDULING

(71) Applicant: QUALCOMM Incorporated, San Diego, CA (US)

(72) Inventors: Alex Kuang-Hsuan TU, San Diego, CA (US); Nikhil Kumar KANSAL, San Diego, CA (US); Suyash RANJAN, San Diego, CA (US)

(21) Appl. No.: 18/737,276

(22) Filed: Jun. 7, 2024

(51) Int. Cl. G06F 9/50

(52) U.S. Cl. CPC G06F 9/505

(57) ABSTRACT

Certain aspects of the present disclosure provide techniques for artificial intelligence (AI) workload scheduling. An example method to distribute execution of at least one AI workload across a plurality of processing cores, generally includes obtaining first characteristics for the plurality of processing cores, obtaining second characteristics for the at least one AI workload, computing one or more metrics for each of the processing cores, based on the first characteristics and the second characteristics, and scheduling the at least one AI workload on at least one of the processing cores, based on the computed metrics and one or more conditions.

### FIELD OF THE DISCLOSURE

Aspects of the present disclosure relate to artificial intelligence (AI), and more particularly, to techniques for AI workload scheduling.

### DESCRIPTION OF RELATED ART

Machine learning is generally the process of producing a trained model (e.g., an artificial neural network, a tree, or other structures), which represents a generalized fit to a set of training data. Applying the trained model to input data produces inferences, which may be used to gain insights into the input data. In some cases, applying the model to the input data is described as “running an inference” or “performing an inference” on the input data.

To train a model and perform inferences on input data, various mathematical operations are performed using various mathematical processing components. For example, multiply-and-accumulate (MAC) units may be used to perform these operations to train a model and perform inferences on input data using the trained model. It should be noted, however, that MAC units may be used for various mathematical operations and are not so limited to use in mathematical operations related to training a model and performing inferences on input data. These mathematical operations may be performed on various types of numerical data with varying complexity. Generally, the complexity of these operations may scale with the bit size of the data and the type of the data. For example, operations using 8-bit integers may be less computationally complex than performing an inference using larger sized integers, such as 64-bit integers. Similarly, operations using a given bit size of integers may be less computationally complex than operations using the given bit size of floating point numbers (e.g., operations performed using 32-bit integers may be less computationally complex than operations using 32-bit floating point numbers, even though the data is the same size in bits).

Power utilization, thermal output, and processing time generally scale with computational complexity. That is, less computationally complex operations generally consume less power and are completed more quickly than more computationally complex operations. Consequently, the execution of more computationally complex operations may result in reduced battery life and delays in the ability to reassign computing resources (e.g., compute cores on a processor, memory, etc.) to other tasks executing on a device.

### SUMMARY

One aspect provides a method to distribute execution of at least one artificial intelligence (AI) workload across a plurality of processing cores. The method includes obtaining first characteristics for the plurality of processing cores; obtaining second characteristics for the at least one AI workload; computing one or more metrics for each of the processing cores, based on the first characteristics and the second characteristics; and scheduling the at least one AI workload on at least one of the processing cores, based on the computed metrics and one or more conditions.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system-on-chip (SoC).

FIG. 2 depicts an example table illustrating power dissipation numbers on compute cores of certain processors running an LLM application.

FIG. 3 depicts a diagram illustrating techniques for artificial intelligence (AI) workload scheduling, in accordance with certain aspects of the present disclosure.

FIG. 4 depicts an example method for artificial intelligence (AI) workload scheduling.

FIG. 5 depicts aspects of an example communications device.

### DETAILED DESCRIPTION

Aspects of the present disclosure provide apparatuses, methods, processing systems, and computer-readable mediums for workload scheduling. For example, the techniques described herein may be utilized for artificial intelligence (AI) and/or machine learning (ML) workload scheduling in systems with multiple processing cores. In the following description, the term AI is used to broadly refer to AI and/or ML.

While AI applications used to be limited to computing devices that were plugged into power, AI is becoming more popular for limited battery size devices (e.g., mobile devices/smartphones). Such “on-device” applications, including Large Language Models (LLMs), are one of the most popular AI use cases. On-device AI workloads may be dispatched to run on various types of intellectual property core (IP) cores. In this context, the term IP core generally refers to a reusable functional block of logic or data used to make a field-programmable gate array (FPGA) or application-specific integrated circuit (ASIC) for a product. As indicated by the name, the design is typically the IP of one party and may be licensed by others for use in their own ICs.

AI workloads are computationally complex and typically consume significant amount of power, regardless of the IP core chosen to run the AI workload on. Improving power savings for AI applications may be particularly important for limited battery size devices. For example, smartphones have a thermal sustainability limit of less than 5 W. Continuous power dissipation beyond this power limit (e.g., even for just for a few seconds) can cause overheating of the phone, causing inconvenience and impacting quality of experience (QoE) of smartphone users.

Aspects of the present disclosure provide techniques and algorithms for making decisions regarding tradeoffs between power dissipation and computation time. For example, certain aspects of the present disclosure provide techniques to distribute execution of AI workloads across processing cores to optimize the overall end user experience, both in terms of power consumed and heat dissipated as well as the time taken to complete the task.

The techniques may be designed to consider that computations required for AI applications can be executed on different IP cores that have different power consumption for the same workload. For example, a same LLM workload can be executed on a central processing unit (CPU), a graphics processing unit (GPU), and/or a neural signal processor (NSP). For processing the same workload, each of these processors may consume different amounts of power and may take different amounts of time to complete processing of the workload. In some cases, power dissipation on processing/computation cores may exceed the thermal sustainability limit.

In some aspects, these techniques may be implemented as algorithms deployed in a software task scheduler or in a hardware task scheduler block. Utilization of the techniques disclosed herein may improve overall end user experience, decreasing power consumption/dissipation and/or increasing computational efficiency (e.g., when using AI applications like LLMs), while optimizing around other factors (e.g., thermals and system bandwidth) which may be key concerns for LLM based applications running on battery powered (e.g., handheld) devices.

### Introduction to System-on-Chip (SoC)

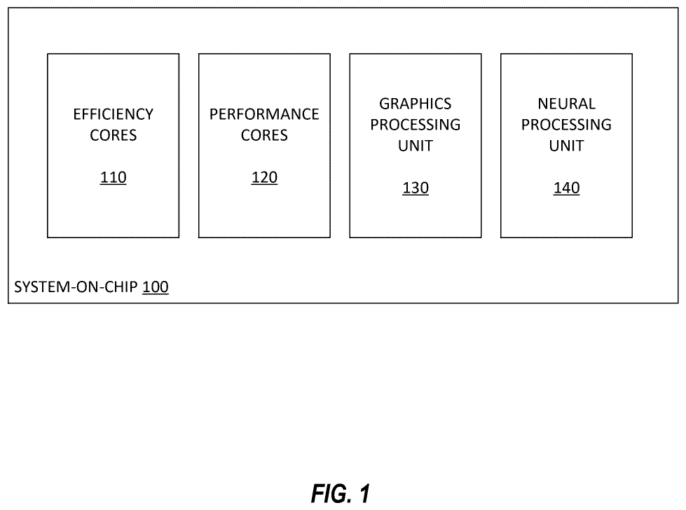

FIG. 1 illustrates an example system-on-chip (SoC) 100 with different types of IP cores on which artificial intelligence workloads can be processed, according to aspects of the present disclosure.

As illustrated, the SoC 100 includes one or more efficiency cores 110, one or more performance cores 120, a graphics processing unit (GPU) 130, and a neural processing unit (NPU) 140, amongst other processing units and components (not illustrated) on which various compute workloads can be processed (e.g., tensor processing units, application-specific integrated circuits (ASICs), digital signal processors (DSPs), and the like). The efficiency cores 110 and the performance cores 120, in some aspects, may be processors implementing a same processing architecture (e.g., processors implementing the ARM or RISC-V architectures). Generally, the efficiency cores 110 may have lower performance (e.g., as measured by a number of operations per second that the efficiency cores 110 can perform) than the performance cores 120, but may use less power than the performance cores 120 in executing a workload. The SoC 100 may include any number of efficiency cores 110 and any number of performance cores 120. The GPU 130 may be a specialized processing unit which is configured to perform large mathematical operations (e.g., matrix, vector, tensor, etc. operations) in parallel.

The NPU 140, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

The NPU 140 may be configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs, such as the NPU 140, may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

Each of the processing units on the SoC 100 (e.g., the efficiency cores 110, the performance cores 120, the GPU 130, the NPU 140, and/or other processing units not illustrated in FIG. 1) generally have different performance characteristics. These performance characteristics may include power slope, leakage power, dynamic clock and voltage scaling points (e.g., points at which processing core clock speed and voltage draw scales upward or downward), instructions-per-clock cycle (IPC) performance levels, and the like.

Workloads executing on the SoC 100 may also be defined by various characteristics which may influence how these workloads, or portions thereof, are scheduled for execution on various processing units of the SoC 100. For example, the workloads may be characterized by a number of stages (e.g., layers) in an artificial intelligence model executing on the SoC 100, a length of an input into the artificial intelligence model, data types associated with each stage or layer of the artificial intelligence model.

### Aspects Related to Al Workload Scheduling

Generally, AI workloads, or portions thereof, may have various performance characteristics which may, in conjunction with system-level operating thresholds such as an amount of available power from which the SoC 100 can draw, thermal thresholds, and the like, influence the scheduling of these workloads on the various processing units (e.g., the efficiency cores 110, the performance cores 120, the GPU 130, the NPU 140, and/or other processing units not illustrated in FIG. 1).

For example, when executing inferencing operations on the SoC 100 using an LLM that is trained to generate tokens (e.g., words or parts of words) in response to an input prompt, a CPU (e.g., the efficiency cores 110 and/or performance cores 120) may spend more time generating a response than the GPU 130 or the NPU 140. Because the CPU may spend a significant amount of time generating the response, the amount of power which can be drawn by the CPU in order to generate a response may actually be greater than the amount of power used by the GPU 130 or the NPU 140 to perform the same operation, as while the GPU 130 and the NPU 140 may have higher power draw characteristics, the GPU 130 and the NPU 140 may spend less time executing an operation.

As noted above, computations required for AI applications can be executed on different computation cores. Techniques proposed herein may be designed to consider that computations required for AI applications can be executed on different IP cores that have different power consumption for the same workload.

For example, a same LLM workload can be executed on a central processing unit (CPU), a graphics processing unit (GPU), and/or a neural signal processor (NSP). For processing the same workload, each of these processors may consume different amounts of power and may take different amounts of time to complete processing of the workload.

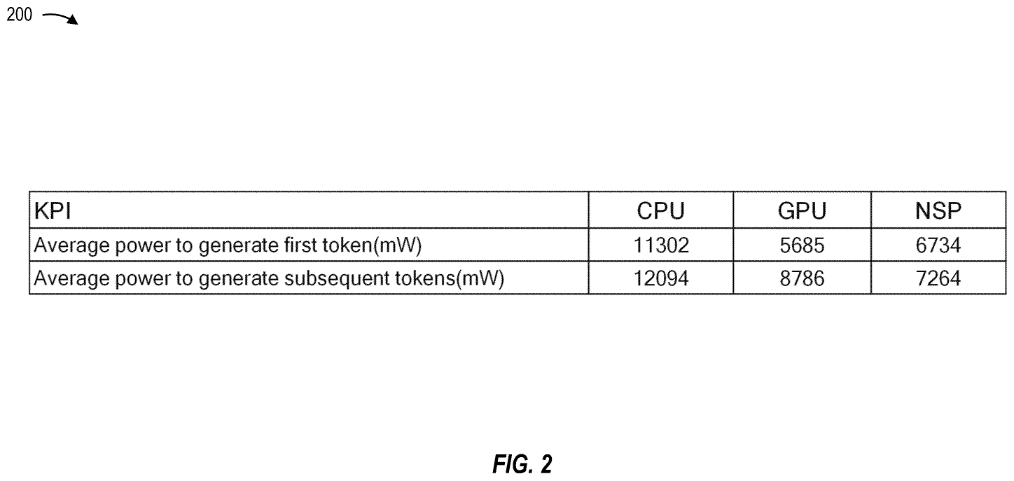

FIG. 2 depicts an example table 200 illustrating power dissipation numbers on compute cores of certain processors running an LLM application. The example shows how values for various key performance indicators (KPIs) may vary significantly depending on what type of IP core is used for an AI workload.

As illustrated, the power dissipation on the computation cores (excluding consumption from the rest of the chipset), may exceed the (e.g., 5 W) thermal sustainability limit. As illustrated, this may be true for different processors (e.g., CPU, GPU, and/or NSP) and for different tokens (e.g., having different token lengths).

However, aspects of the present disclosure provide techniques and algorithms for making decisions regarding tradeoffs between power dissipation and computation time. For example, certain aspects of the present disclosure provide techniques to distribute execution of AI workloads across processing cores to optimize the overall end user experience, both in terms of power consumed and heat dissipated as well as the time taken to complete the task. In some aspects, these techniques may be implemented as algorithms deployed in a software task scheduler or in a hardware task scheduler block.

In this sense, processing core selection/IP scheduling may be considered power performance aware. This awareness may be especially useful for AI (e.g., LLM) workloads having multiple stages, where each of the stages may benefit from (e.g., or require) different types of processing.

For example, in many AI workload scenarios (e.g., LLM), a user's sensitivity to power consumption/dissipation and computation time may be different between different stages. For LLM applications, for the first token generation stage, user sensitivity may be very high for the computation turnaround time (e.g., which may be prioritized), and power consumption/dissipation may be less important (e.g., lower user sensitivity). However, after the first token is generated, a user is likely to prioritize (e.g., be more sensitive to) power dissipation/consumption and overheating issues. Aspects of the present disclosure provide techniques/algorithms for selecting optimal core(s) for each stage to provide an improved user experience.

When attempting to select optimal cores for each stage/workload, many factors/inputs may be considered, as described below. For example, a quantity of stages for each AI workload type may be considered. For example, for LLM workloads, a first stage (stage1) may be defined as the start of the workload to completion of first token generation, and a second stage (stage2) may be defined as the beginning of second token generation to the end of the workload.

When selecting the optimal cores for each stage/workload, a user input/preference (e.g., a most desired user behavior) for each stage may be considered. For example, a selection (e.g., which may be configured for a particular stage) may be made between (e.g., (pre) configured options/modes) prioritizing improving computation time, improving power (e.g., dissipation/consumption), or a balance between improving time-power. For example, for LLM workloads, stage 1 may be defined/configured to prioritize <best computation time> and stage 2 may be defined/configured to use a <time-power balance> or a <best power> mode/option.

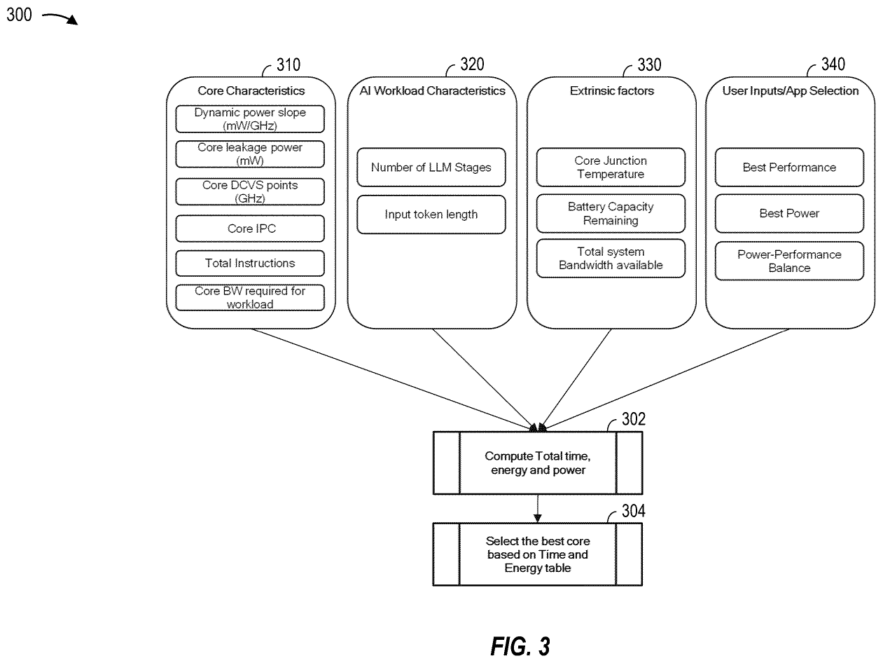

As illustrated in example diagram 300 of FIG. 3, the selection of the optimal cores (at 304) for each stage/workload may consider certain features/parameters/metrics (computed at 302) of one or more (or each) of the processing cores (e.g., CPU, GPU and NSP) to which the AI workload/task may be scheduled.

For example, as illustrated at 310, a processing core's dynamic power slope (e.g., mW/GHz), leakage power (e.g., mW), and/or dynamic frequency and voltage operating points (e.g., dynamic clock and voltage scaling (DCVS) points and/or dynamic voltage and frequency scaling (DVFS) points) may be considered. Additionally, for a specific AI workload, a quantity of instructions per cycle (IPC) and a total quantity of instructions for the workload may be considered.

Based on these factors/inputs/considerations, at 302, certain metrics may be computed for each stage and/or for each processing core. For example, for each available core and each DCVS/DVFS point, a total computation time total power/energy consumption may be computed. A selection of one or more core(s) may then be made (at 304), based on the factors/inputs, the metrics, and the user input/desired behavior selections, and based on a time and energy computation table (e.g., a lookup table (LUT)). Accordingly, the AI workload (which may be associated with various stages) may be scheduled/distributed to the selected core(s).

In some aspects, processing core selection/IP scheduling may be bandwidth aware (in addition, or as an alternative to being power aware). This bandwidth awareness may be especially useful for AI (e.g., LLM) workloads having very high data transfer requirements (e.g., data bandwidth) between the computing and external memory (DRAM).

When AI scenarios/applications are running concurrently with other scenarios/applications like camera recording, modem data download, or gaming, the data transfer requirements of the concurrent scenarios/applications can become a bottleneck for the system. In such scenarios, the AI workload or the other concurrent scenario(s) may need to be stopped, since data bandwidth requirements may exceed the maximum bandwidth capacity that the system can provide. Different cores running the same AI workload may have different data bandwidth requirements. Aspects of the present disclosure provide techniques/algorithms for selecting a processing core(s) which can run an AI workload along with other concurrent scenario(s), based on awareness of bandwidth metrics and/or requirements.

Bandwidth aware core selection/IP scheduling may consider many factors/inputs, as described below. For example, certain information for each AI workload type and/or one or more (or each) of the (available for selection) processing cores (e.g., CPU, GPU and NSP) may be considered. Such information may include, for example, processing core DCVS/DVFS points, a total bandwidth requirement for a processing core for each DCVS/DVFS point, and/or input priorities for AI workload(s) and Non-AI workload(s) to be scheduled.

In some cases, how AI workloads are deployed may depend on available bandwidth and whether bandwidth should be allocated to prioritize AI or non-AI workloads. For example, based on the inputs/factors described above, an available bandwidth (BW) for an AI workload, for each stage and for each core, may be computed as:

$$Available BW for AI workload = Maximum System BW - BW consumed by other non - AI workloads .$$

A core (or cores) may then be selected based on the computation and the inputs/factors, based on a desired priority.

For example, if a Non-AI workload is to be prioritized (e.g., has a highest/higher priority level/value than a priority level/value of an AI workload), a processing core may be selected for the AI workload at a DCVS/DVFS point where the required bandwidth for the AI workload is less than (e.g., or equal to) the available bandwidth for the AI workload (as computed above). If an AI workload is to be prioritized (e.g., has a highest/higher priority level/value than a priority level/value of a non-AI workload), a processing core may be selected for the AI workload (e.g., based on a power performance aware algorithm as described above), and the remaining bandwidth (after scheduling the AI workload) may be given/scheduled to the non-AI workload.

In some aspects, processing core selection/IP scheduling may be based on various system parameters (e.g., core junction temperature (Tj), remaining battery capacity, etc.). According to certain aspects, for example, an intelligent algorithm may be used to dynamically select/schedule cores/IPs/modes based on core junction temperature. If core junction temperature increases, for example, throttling may occur, resulting in a negative performance impact. If core junction temperature is approaching a throttle point (e.g., a threshold), the algorithm may switch from a <best computation time> mode to a <time-power balance> mode or to a <best power> mode.

Similarly, based on remaining battery capacity, the intelligent algorithm may select an IP which has lower power consumption, which can be beneficial for power/sustained performance. If the remaining battery capacity is approaching (or reaches) a threshold, for example, the algorithm may switch from a <best computation time> option/mode to a <time-power balance> option/mode and/or to a <best power> option/mode.

According to certain aspects, as illustrated at 320 of FIG. 3, processing core selection/IP scheduling may be based on a number of LLM stages and input token characteristic(s) such as input token length. In some aspects, depending on the token inputs and token input characteristics (e.g., length), the algorithm may intelligently select the best IP/mode (e.g., in order to save power without hurting performance). For example, for lower token lengths, certain IPs may be more effective for managing the power/performance tradeoff, and an IP may be chosen accordingly.

As illustrated, certain aspects include techniques for AI workload scheduling that consider extrinsic factors 330 and/or user inputs 340. As illustrated, extrinsic factors may include core junction temperature (Tj), remaining battery capacity, and total system bandwidth available. As illustrated, user inputs may include selections, such as whether a user wants to optimize IP core selection to achieve best performance, best power, or a balance of performance and power for a particular application associated with an AI workload.

As illustrated at 302, the various factors and inputs/characteristics may be used to compute certain metrics, which may include a total time, energy consumed, and/or power consumed. These metrics may be for a particular AI workload, for a particular processor/core, and/or for particular DCVS/DVFS points.

As illustrated at 304, a processor/core/IP may be selected (and an AI workload scheduled thereto) based on the computed metrics and/or the factors/inputs/characteristics described above. The selection may be based on one or more tables (e.g., lookup tables (LUTs) for time/energy/power values).

Utilization of the techniques disclosed herein may improve overall end user experience, decreasing power consumption/dissipation and/or increasing computational efficiency (e.g., when using AI applications like LLMs), while optimizing around other factors (e.g., thermals and system bandwidth) which may be key concerns for LLM based applications running on battery powered (e.g., handheld) devices.

### Example Operations

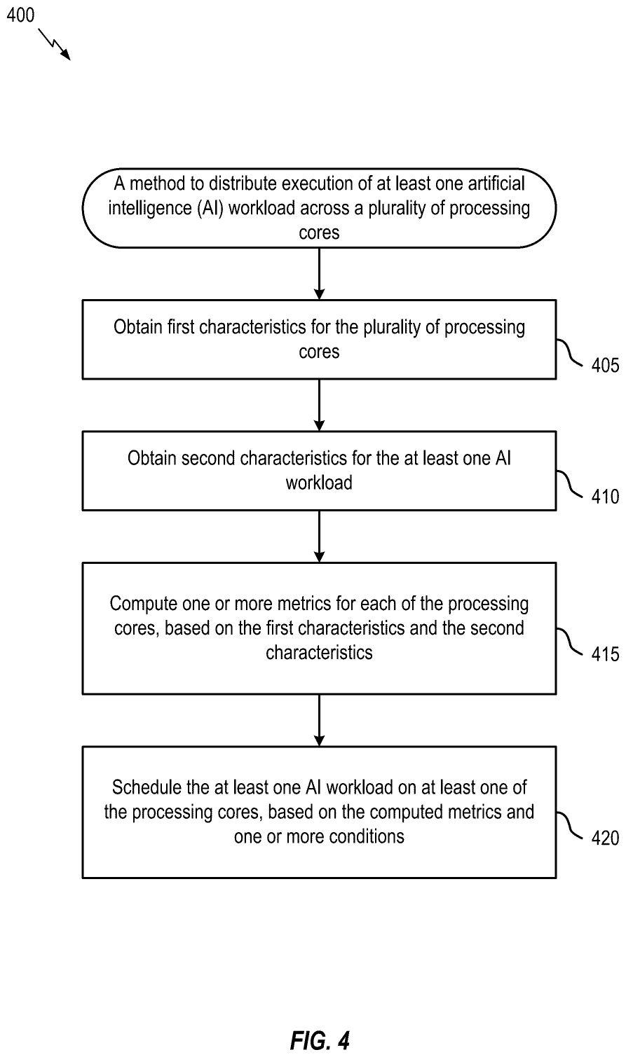

FIG. 4 shows an example of a method 400 of distributing at least one artificial intelligence (AI) workload across a plurality of processing cores.

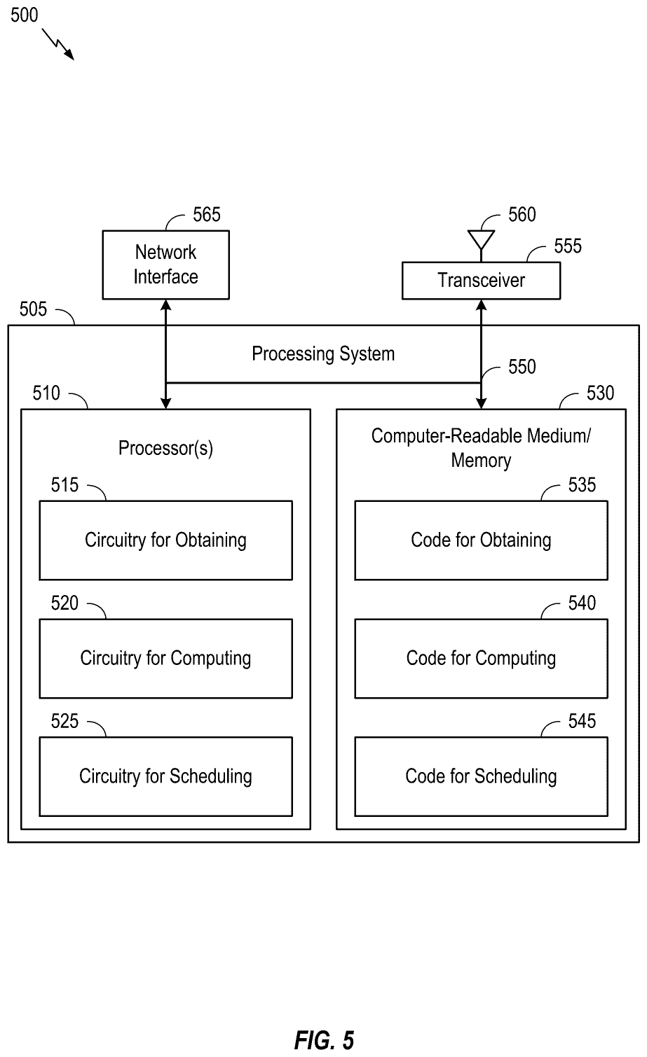

Method 400 begins at step 405 with obtaining first characteristics for the plurality of processing cores. In some cases, the operations of this step refer to, or may be performed by, circuitry for obtaining and/or code for obtaining as described with reference to FIG. 5.

Method 400 then proceeds to step 410 with obtaining second characteristics for the at least one AI workload. In some cases, the operations of this step refer to, or may be performed by, circuitry for obtaining and/or code for obtaining as described with reference to FIG. 5.

Method 400 then proceeds to step 415 with computing one or more metrics for each of the processing cores, based on the first characteristics and the second characteristics. In some cases, the operations of this step refer to, or may be performed by, circuitry for computing and/or code for computing as described with reference to FIG. 5.

Method 400 then proceeds to step 420 with scheduling the at least one AI workload on at least one of the processing cores, based on the computed metrics and one or more conditions. In some cases, the operations of this step refer to, or may be performed by, circuitry for scheduling and/or code for scheduling as described with reference to FIG. 5.

In some aspects, the plurality of processing cores comprise at least one of: a central processing unit (CPU), a graphics processing unit (GPU), a neural processor, or another type of processing core.

In some aspects, the at least one AI workload involves multiple stages; and metrics are computed for each of the processing cores for each of the multiple stages.

In some aspects, the scheduling comprises scheduling different stages to different processing cores based on different conditions.

In some aspects, the first characteristics comprise at least one of a dynamic power slope, a leakage power, or dynamic frequency and voltage operating points; and the second characteristics comprise at least one of a number of stages for the at least one AI workload, instructions per cycle (IPC) for the at least one AI workload, or total instructions for the at least one AI workload.

In some aspects, the dynamic frequency and voltage operating points comprise at least one of dynamic clock and voltage scaling (DCVS) points or dynamic voltage and frequency scaling (DVFS) points.

In some aspects, the metrics comprise at least one of a compute time, a total power consumption, or total energy consumption for the at least one AI workload.

In some aspects, the one or more conditions relate to a desired behavior.

In some aspects, the desired behavior relates to optimization of compute time, total power consumption, or a balance of compute time and power consumption.

In some aspects, the first characteristics comprise dynamic frequency and voltage operating points and a total bandwidth for each dynamic frequency and voltage operating point; and the second characteristics comprise a priority level and a bandwidth requirement for a given AI workload.

In some aspects, the dynamic frequency and voltage operating points comprise at least one of dynamic clock and voltage scaling (DCVS) points or dynamic voltage and frequency scaling (DVFS) points.

In some aspects, the metrics comprise an available bandwidth for the given AI workload for each processing core at one or more of the dynamic frequency and voltage operating points.

In some aspects, the one or more conditions depend on the priority level for the given AI workload relative to a priority level for a non-AI workload.

In some aspects, when the priority level for the given AI workload is less than the priority level for the non-AI workload, the scheduling comprises: scheduling the given AI workload on a selected one of the processing cores at a dynamic frequency and voltage operating point where the required bandwidth of the selected processing core for AI workload is less than the available bandwidth after scheduling the non-AI workload.

In some aspects, when the priority level for the given AI workload is greater than the priority level for the non-AI workload, the scheduling comprises: scheduling the given AI workload on a selected one of the processing cores at a dynamic frequency and voltage operating point based on the computed metrics and one or more conditions; and allocating remaining bandwidth of the selected processing core for the non-AI workload.

In some aspects, the one or more conditions relate to at least one of a desired behavior, a core junction temperature, and a battery capacity condition.

In some aspects, the desired behavior relates to optimization of compute time, total power consumption, or a balance of compute time and power consumption.

In some aspects, the desired behavior changes based on at least one of: the core junction temperature relative to a first threshold, or the battery capacity condition relative to a second threshold.

In some aspects, the second characteristics comprise at least one of a token input length or a token input characteristic for the at least one AI workload.

In some aspects, the one or more conditions relate to a desired behavior, and the desired behavior changes based on the token input length relative to at least one threshold.

In one aspect, method 400, or any aspect related to it, may be performed by an apparatus, such as communications device 500 of FIG. 5, which includes various components operable, configured, or adapted to perform the method 400. Communications device 500 is described below in further detail.

Note that FIG. 4 is just one example of a method, and other methods including fewer, additional, or alternative steps are possible consistent with this disclosure.

### Example Communications Device(s)

FIG. 5 depicts aspects of an example communications device 500.

The communications device 500 includes a processing system 505 coupled to the transceiver 555 (e.g., a transmitter and/or a receiver) and/or a network interface 565. The transceiver 555 is configured to transmit and receive signals for the communications device 500 via the antenna 560, such as the various signals as described herein. The network interface 565 is configured to obtain and send signals for the communications device 500 via communication link(s). The processing system 505 may be configured to perform processing functions for the communications device 500, including processing signals received and/or to be transmitted by the communications device 500.

The processing system 505 includes one or more processors 510. The one or more processors 510 are coupled to a computer-readable medium/memory 530 via a bus 550. In certain aspects, the computer-readable medium/memory 530 is configured to store instructions (e.g., computer-executable code) that when executed by the one or more processors 510, cause the one or more processors 510 to perform the method 400 described with respect to FIG. 4, or any aspect related to it. Note that reference to a processor of communications device 500 performing a function may include one or more processors 510 of communications device 500 performing that function.

In the depicted example, the computer-readable medium/memory 530 stores code (e.g., executable instructions), such as code for obtaining 535, code for computing 540, and code for scheduling 545. Processing of the code for obtaining 535, code for computing 540, and code for scheduling 545 may cause the communications device 500 to perform the method 400 described with respect to FIG. 4, or any aspect related to it.

The one or more processors 510 include circuitry configured to implement (e.g., execute) the code stored in the computer-readable medium/memory 530, including circuitry such as circuitry for obtaining 515, circuitry for computing 520, and circuitry for scheduling 525. Processing with circuitry for obtaining 515, circuitry for computing 520, and circuitry for scheduling 525 may cause the communications device 500 to perform the method 400 described with respect to FIG. 4, or any aspect related to it.

Various components of the communications device 500 may provide means for performing the method 400 described with respect to FIG. 4, or any aspect related to it. Means for transmitting, sending or outputting for transmission may include transceivers and/or antenna(s) and/or the transceiver 555 and the antenna 560 of the communications device 500 in FIG. 5. Means for receiving or obtaining may include transceivers and/or antenna(s) and/or the transceiver 555 and the antenna 560 of the communications device 500 in FIG. 5.

### Example Clauses

Implementation examples are described in the following numbered clauses:

Clause 1: A method to distribute execution of at least one artificial intelligence (AI) workload across a plurality of processing cores, the method comprising: obtaining first characteristics for the plurality of processing cores; obtaining second characteristics for the at least one AI workload; computing one or more metrics for each of the processing cores, based on the first characteristics and the second characteristics; and scheduling the at least one AI workload on at least one of the processing cores, based on the computed metrics and one or more conditions.

Clause 2: The method of Clause 1, wherein the plurality of processing cores comprise at least one of: a central processing unit (CPU), a graphics processing unit (GPU), a neural processor, or another type of processing core.

Clause 3: The method of any one of Clauses 1-2, wherein: the at least one AI workload involves multiple stages; and metrics are computed for each of the processing cores for each of the multiple stages.

Clause 4: The method of Clause 3, wherein the scheduling comprises scheduling different stages to different processing cores based on different conditions.

Clause 5: The method of any one of Clauses 1-4, wherein: the first characteristics comprise at least one of a dynamic power slope, a leakage power, or dynamic frequency and voltage operating points; and the second characteristics comprise at least one of a number of stages for the at least one AI workload, instructions per cycle (IPC) for the at least one AI workload, or total instructions for the at least one AI workload.

Clause 6: The method of Clause 5, wherein the dynamic frequency and voltage operating points comprise at least one of dynamic clock and voltage scaling (DCVS) points or dynamic voltage and frequency scaling (DVFS) points.

Clause 7: The method of Clause 5, wherein the metrics comprise at least one of a compute time, a total power consumption, or total energy consumption for the at least one AI workload.

Clause 8: The method of Clause 7, wherein the one or more conditions relate to a desired behavior.

Clause 9: The method of Clause 8, wherein the desired behavior relates to optimization of compute time, total power consumption, or a balance of compute time and power consumption.

Clause 10: The method of any one of Clauses 1-9, wherein: the first characteristics comprise dynamic frequency and voltage operating points and a total bandwidth for each dynamic frequency and voltage operating point; and the second characteristics comprise a priority level and a bandwidth requirement for a given AI workload.

Clause 11: The method of Clause 10, wherein the dynamic frequency and voltage operating points comprise at least one of dynamic clock and voltage scaling (DCVS) points or dynamic voltage and frequency scaling (DVFS) points.

Clause 12: The method of Clause 10, wherein the metrics comprise an available bandwidth for the given AI workload for each processing core at one or more of the dynamic frequency and voltage operating points.

Clause 13: The method of Clause 12, wherein the one or more conditions depend on the priority level for the given AI workload relative to a priority level for a non-AI workload.

Clause 14: The method of Clause 13, wherein when the priority level for the given AI workload is less than the priority level for the non-AI workload, the scheduling comprises: scheduling the given AI workload on a selected one of the processing cores at a dynamic frequency and voltage operating point where the required bandwidth of the selected processing core for AI workload is less than the available bandwidth after scheduling the non-AI workload.

Clause 15: The method of Clause 13, wherein when the priority level for the given AI workload is greater than the priority level for the non-AI workload, the scheduling comprises: scheduling the given AI workload on a selected one of the processing cores at a dynamic frequency and voltage operating point based on the computed metrics and one or more conditions; and allocating remaining bandwidth of the selected processing core for the non-AI workload.

Clause 16: The method of any one of Clauses 1-15, wherein the one or more conditions relate to at least one of a desired behavior, a core junction temperature, and a battery capacity condition.

Clause 17: The method of Clause 16, wherein: the desired behavior relates to optimization of compute time, total power consumption, or a balance of compute time and power consumption.

Clause 18: The method of Clause 17, wherein the desired behavior changes based on at least one of: the core junction temperature relative to a first threshold, or the battery capacity condition relative to a second threshold.

Clause 19: The method of any one of Clauses 1-18, wherein the second characteristics comprise at least one of a token input length or a token input characteristic for the at least one AI workload.

Clause 20: The method of Clause 19, wherein the one or more conditions relate to a desired behavior, and the desired behavior changes based on the token input length relative to at least one threshold.

Clause 21: An apparatus, comprising: at least one memory comprising executable instructions; and at least one processor configured to execute the executable instructions and cause the apparatus to perform a method in accordance with any combination of Clauses 1-20.

Clause 22: An apparatus, comprising means for performing a method in accordance with any combination of Clauses 1-20.

Clause 23: A non-transitory computer-readable medium comprising executable instructions that, when executed by at least one processor of an apparatus, cause the apparatus to perform a method in accordance with any combination of Clauses 1-20.

Clause 24: A computer program product embodied on a computer-readable storage medium comprising code for performing a method in accordance with any combination of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for obtaining, means for computing, and means for scheduling may comprise one or more processors, such as one or more of the processors described above with reference to FIG. 5.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for distributing execution of at least one artificial intelligence (AI) workload across a plurality of processing cores, comprising:
at least one memory comprising computer-executable instructions; and
one or more processors configured to execute the computer-executable instructions and cause the apparatus to:
obtain first characteristics for the plurality of processing cores;
obtain second characteristics for the at least one AI workload;
compute one or more metrics for each of the processing cores, based on the first characteristics and the second characteristics; and
schedule the at least one AI workload on at least one of the processing cores, based on the computed metrics and one or more conditions.

2. The apparatus of claim 1, wherein the plurality of processing cores comprise at least one of:
a central processing unit (CPU),
a graphics processing unit (GPU),
a neural processor, or
another type of processing core.

3. The apparatus of claim 1, wherein:
the at least one AI workload involves multiple stages; and
metrics are computed for each of the processing cores for each of the multiple stages.

4. The apparatus of claim 3, wherein in order to schedule the at least one AI workload on at least one of the processing cores, the one or more processors are further configured to schedule different stages to different processing cores based on different conditions.

5. The apparatus of claim 1, wherein:
the first characteristics comprise at least one of a dynamic power slope, a leakage power, or dynamic frequency and voltage operating points; and
the second characteristics comprise at least one of a number of stages for the at least one AI workload, instructions per cycle (IPC) for the at least one AI workload, or total instructions for the at least one AI workload.

6. The apparatus of claim 5, wherein the dynamic frequency and voltage operating points comprise at least one of dynamic clock and voltage scaling (DCVS) points or dynamic voltage and frequency scaling (DVFS) points.

7. The apparatus of claim 5, wherein the metrics comprise at least one of a compute time, a total power consumption, or total energy consumption for the at least one AI workload.

8. The apparatus of claim 7, wherein the one or more conditions relate to a desired behavior.

9. The apparatus of claim 8, wherein the desired behavior relates to optimization of compute time, total power consumption, or a balance of compute time and power consumption.

10. The apparatus of claim 1, wherein:
the first characteristics comprise dynamic frequency and voltage operating points and a total bandwidth for each dynamic frequency and voltage operating point; and
the second characteristics comprise a priority level and a bandwidth requirement for a given AI workload.

11. The apparatus of claim 10, wherein the dynamic frequency and voltage operating points comprise at least one of dynamic clock and voltage scaling (DCVS) points or dynamic voltage and frequency scaling (DVFS) points.

12. The apparatus of claim 10, wherein the metrics comprise an available bandwidth for the given AI workload for each processing core at one or more of the dynamic frequency and voltage operating points.

13. The apparatus of claim 12, wherein the one or more conditions depend on the priority level for the given AI workload relative to a priority level for a non-AI workload.

14. The apparatus of claim 13, wherein in order to schedule the at least one AI workload on at least one of the processing cores when the priority level for the given AI workload is less than the priority level for the non-AI workload, the one or more processors are further configured to schedule the given AI workload on a selected one of the processing cores at a dynamic frequency and voltage operating point where the required bandwidth of the selected processing core for AI workload is less than the available bandwidth after scheduling the non-AI workload.

15. The apparatus of claim 13, wherein in order to schedule the at least one AI workload on at least one of the processing cores when the priority level for the given AI workload is greater than the priority level for the non-AI workload, the one or more processors are further configured to:
schedule the given AI workload on a selected one of the processing cores at a dynamic frequency and voltage operating point based on the computed metrics and one or more conditions; and
allocate remaining bandwidth of the selected processing core for the non-AI workload.

16. The apparatus of claim 1, wherein the one or more conditions relate to at least one of a desired behavior, a core junction temperature, and a battery capacity condition.

17. The apparatus of claim 16, wherein:
the desired behavior relates to optimization of compute time, total power consumption, or a balance of compute time and power consumption; and
the desired behavior changes based on at least one of: the core junction temperature relative to a first threshold, or the battery capacity condition relative to a second threshold.

18. The apparatus of claim 1, wherein:
the second characteristics comprise at least one of a token input length or a token input characteristic for the at least one AI workload,
the one or more conditions relate to a desired behavior, and
the desired behavior changes based on the token input length relative to at least one threshold.

19. A method to distribute execution of at least one artificial intelligence (AI) workload across a plurality of processing cores, the method comprising:
obtaining first characteristics for the plurality of processing cores;
obtaining second characteristics for the at least one AI workload;
computing one or more metrics for each of the processing cores, based on the first characteristics and the second characteristics; and
scheduling the at least one AI workload on at least one of the processing cores, based on the computed metrics and one or more conditions.

20. An apparatus for distributing execution of at least one artificial intelligence (AI) workload across a plurality of processing cores, comprising:
means for obtaining first characteristics for the plurality of processing cores;
means for obtaining second characteristics for the at least one AI workload;
means for computing one or more metrics for each of the processing cores, based on the first characteristics and the second characteristics; and
means for scheduling the at least one AI workload on at least one of the processing cores, based on the computed metrics and one or more conditions.
